(19) United States
(12) Patent Application Publication
(10) Pub. No.: US 2025/0379212 A1
(43) Pub. Date: Dec. 11, 2025

(54) BATTERY CELLS WITH LARGE GRAIN BOUNDARY AND PRELITHIATED ALUMINUM ANODE ELECTRODE

(71) Applicant: GM GLOBAL TECHNOLOGY OPERATIONS LLC, Detroit, MI (US)

(72) Inventors: Zhe LI, Shanghai (CN); Henry ZHAN, Shanghai (CN); Qili SU, Shanghai (CN); Haijing LIU, Shanghai (CN); Congjie WANG, Shanghai (CN)

(21) Appl. No.: 18/760,389

(22) Filed: Jul. 1, 2024

(30) Foreign Application Priority Data
Jun. 11, 2024 (CN) 2024107485948

(51) Int. Cl. H01M 4/134; H01M 4/02; H01M 4/36; H01M 4/40; H01M 4/46; H01M 4/62; H01M 4/66; H01M 10/0525; H01M 10/0562; H01M 10/0585

(52) U.S. Cl. CPC H01M 4/134; H01M 4/366; H01M 4/405; H01M 4/463; H01M 4/62; H01M 4/661; H01M 10/0525; H01M 10/0562; H01M 10/0585; H01M 2004/027; H01M 2004/028; H01M 2300/0068

(57) ABSTRACT

A battery cell includes C cathode electrodes, A anode electrodes, and S separators, where A, C, and S are integers. Each of the A anode electrodes includes an annealed aluminum foil layer and a lithium aluminum layer arranged on one side of the annealed aluminum foil layer.

### CROSS-REFERENCE TO RELATED APPLICATIONS

This application claims the benefit of Chinese Patent Application No. 202410748594.8 filed on Jun. 11, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including prelithiated aluminum anode electrodes.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes, A anode electrodes, and S separators, where A, C, and S are integers. Each of the A anode electrodes includes an annealed aluminum foil layer and a lithium aluminum layer arranged on one side of the annealed aluminum foil layer.

In other features, the S separators comprise a solid electrolyte. The C cathode electrodes comprise a cathode active material layer including a cathode active material and a solid electrolyte arranged on one or both sides of a cathode current collector.

In other features, the solid electrolyte is selected from a group consisting of a sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, a borate-based solid electrolyte, and combinations thereof.

In other features, the battery cell comprises an all-solid-state battery cell.

In other features, the S separators comprise a solid electrolyte and a liquid electrolyte, the C cathode electrodes comprise a cathode active material layer including a cathode active material, a solid electrolyte, and a liquid electrolyte, and the cathode active material layer is arranged on one or both sides of a cathode current collector.

In other features, the solid electrolyte is selected from a group consisting of a sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, a borate-based solid electrolyte, and combinations thereof.

In other features, the C cathode electrodes include a cathode active material layer comprising cathode active material and a liquid electrolyte and the S separators include a separator layer.

In other features, the separator layer is selected from a group consisting of a polyolefin-based separator, a cellulose separator, a polyvinylidene fluoride (PVDF) membrane, a porous polyimide membrane, and a ceramic-coated separator.

In other features, the separator layer is selected from a group consisting of a polyimide (PI) nanofiber-based nonwoven, a nano-sized Al2O3 and poly(lithium 4-styrenesulfonate)-coated polyethylene membrane, a SiO2 coated polyethylene (PE) separator, a co-polyimide-coated polyethylene separator, a polyetherimide (PEI) separator, an expanded polytetrafluoroethylene reinforced polyvinylidenefluoride-hexafluoropropylene separator, and a sandwich-structured PVdF/PMIA/PVdF nanofibrous separator.

In other features, the C cathode electrodes include a cathode active material selected from a group consisting of a layered oxide, an olivine-type oxide, a monoclinic-type oxide, a spinel-type oxide, a tavorite, sulfur, Li2S, and combinations thereof.

A battery cell, comprising C cathode electrodes, A anode electrodes, and S separators, where A, C, and S are integers. Each of the A anode electrodes includes an annealed aluminum foil layer, a lithium aluminum layer arranged on one side of the annealed aluminum foil layer, and a copper current collector arranged on one side of the lithium aluminum layer.

In other features, the C cathode electrodes include a cathode active material layer comprising a cathode active material and a solid electrolyte. The solid electrolyte is selected from a group consisting of a sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, a borate-based solid electrolyte, and combinations thereof.

In other features, the S separators comprise a solid electrolyte. The solid electrolyte is selected from a group consisting of a sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, a borate-based solid electrolyte, and combinations thereof.

In other features, the C cathode electrodes include a cathode active material layer comprising a cathode active material and a liquid electrolyte, and the S separators include a separator layer. The separator layer is selected from a group consisting of a polyolefin-based separator, a cellulose separator, a polyvinylidene fluoride (PVDF) membrane, a porous polyimide membrane, and a ceramic-coated separator.

In other features, the separator layer is selected from a group consisting of a polyimide (PI) nanofiber-based nonwoven, a nano-sized Al2O3 and poly(lithium 4-styrenesulfonate)-coated polyethylene membrane, a SiO2 coated polyethylene (PE) separator, a co-polyimide-coated polyethylene separator, a polyetherimide (PEI) separator, an expanded polytetrafluoroethylene reinforced polyvinylidenefluoride-hexafluoropropylene separator, and a sandwich-structured PVdF/PMIA/PVdF nanofibrous separator.

In other features, the C cathode electrodes include a cathode active material selected from a group consisting of a layered oxide, an olivine-type oxide, a monoclinic-type oxide, a spinel-type oxide, a tavorite, sulfur, Li2S, and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell according to the present disclosure;

FIGS. 2 and 3 are side cross sections of an example of an anode electrode before and after aging/prelithiation, respectively, according to the present disclosure;

FIGS. 4 to 9 are side cross sections of examples of battery cells including prelithiated aluminum anode electrodes according to the present disclosure;

FIG. 10 illustrates molecular structures of aluminum foil and annealed and prelithiated aluminum foil according to the present disclosure;

FIGS. 11A and 11B illustrate examples of grain boundary distributions (>15°) for aluminum foil and annealed aluminum foil, respectively, according to the present disclosure;

FIG. 12 illustrates an example of lithium ion diffusion paths within LiAl alloy according to the present disclosure;

FIG. 13 is a graph showing voltage as a function of capacity for prelithiated aluminum foil and prelithiated aluminum foil after annealing according to the present disclosure; and

FIG. 14 is a graph showing capacity as a function of cycles for prelithiated aluminum foil and prelithiated aluminum foil after annealing according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Aluminum has attracted attention as an anode active material for battery cells such as high-energy-density all-solid-state batteries (ASSB). Aluminum is abundant and low cost and has a suitable operating potential (˜0.3 V vs Li+/Li). Aluminum has a theoretical capacity of 990 mAh/g (from Al (α phase, fcc) to LiAl (β phase, cubic) and a volume change of 96%, which is lower than the 310% volume change of silicon anode electrodes. However, even after prelithiation, aluminum has poor initial Coulombic efficiency and capacity delivery, which may be due to diffusional trapping of active lithium and mechanical fracture.

The present disclosure relates to an aluminum anode active material layer for an anode electrode of battery cells such as an ASSB cells, semi solid state battery cells, or liquid-electrolyte-based battery. According to the present disclosure, aluminum foil is rolled and then annealed to refine the aluminum grains and increase the sharpness of grain boundaries (GB).

The annealed aluminum foil is mechanically bonded to other layers of the anode electrode using a roll process and then aged/prelithiated. The use of annealed Al foil effectively increases the GB distribution and facilitates lithium-ion diffusion within the anode electrode. The pretreatment triggers a spontaneous transformation from α phase (Al structure) to the β phase (LiAl), which compensates for active lithium loss to enhance cell cycling.

The aluminum foil layer is rolled one or more times to ensure precise control of foil thickness and shape. In some examples, a thickness of aluminum foil layer after rolling is in a range from 2 μm to 80 μm. In some examples, a thickness of aluminum foil layer after rolling is in a range from 30 μm to 50 μm (e.g., 40 μm). In some examples, the aluminum foil layer comprises 94.0 wt % to 99.99 wt % of aluminum. In some examples, the aluminum foil layer comprises 98.0 wt % to 99.95 wt % of aluminum (e.g., 99 wt %).

After rolling, the aluminum foil layer is annealed. During annealing, recrystallization and polygonization are initiated to refine the grains and increase the sharpness of the grain boundaries. In some examples, annealing is performed at a temperature in a range from 250° C. to 550° C. In some examples, annealing is performed at a temperature in a range from 300° C. to 400° C. (e.g., 350° C.). In some examples, the annealing period is in a range from 10 minutes to 24 hours. In some examples, the annealing period is in a range from 30 minutes to 90 minutes (e.g., 60 minutes).

In some examples, the grain boundary distribution) (>15° after annealing is in a range from 46% to 80%. In some examples, the grain boundary distribution (>15°) after annealing is in a range from 60% to 70% (e.g., 65%). After rolling and annealing, the aluminum foil layers are mechanically bonded with other layers such as lithium metal foil layer(s) and/or a separator layer.

Performance of battery cells such as ASSBs is enhanced by the large-grain-boundary and prelithiated aluminum anode electrodes. The battery cells demonstrate enhanced initial Coulombic efficiency (86%) and increased capacity delivery (143 mAh/g at 0.1° C.).

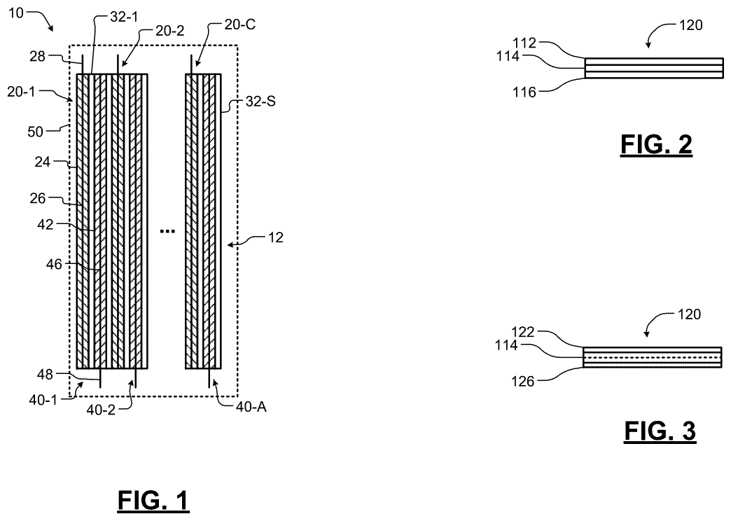

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include an anode active material layer 42 and an anode current collector 46.

During charging/discharging, the A anode electrodes 40 and the C cathode electrodes 20 exchange lithium ions. In some examples, the cathode active material layers 24 comprise coatings including one or more active materials, one or more conductive additives, and/or one or more binder materials that are applied to the current collectors. In some examples, the S separators comprise solid electrolyte or a separator layer.

In some examples, the cathode current collector 26 comprises metal foil, metal mesh, perforated metal, 3 dimensional (3D) metal foam, and/or expanded metal. In some examples, the cathode current collectors are made of one or more materials selected from a group consisting of stainless steel, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIGS. 2 and 3, an example of an anode electrode 120 according to the present disclosure is shown during processing. The anode electrode 120 includes lithium metal foil layers 112 and 116 arranged on opposite sides of an annealed aluminum foil layer 114. In some examples, the annealed aluminum foil layer 114 is rolled (pressed and/or heated) using rollers prior to annealing and mechanical bonding with other layers such as the lithium metal foil layers 112 and 116. The aluminum foil layer 114 is rolled one or more times to ensure precise control of foil thickness and shape. The lithium metal foil layers 112 and 116 are mechanically bonded on opposite sides of the aluminum foil layer 114 using a roll process.

In FIG. 3, the aluminum foil layer 114 and the lithium metal foil layers 112 and 116 are aged after mechanical bonding for a predetermined period to allow prelithiation to occur. The lithium metal foil layers 112 and 116 are prelithiated to create lithium aluminum (LiAl) layers 122 and 126 arranged on opposite sides of the aluminum foil layer 114.

As can be appreciated, the anode electrode may include other arrangements of layers. For example, the anode electrode may include rolled and annealed aluminum foil layers arranged on sides of a lithium metal foil layer. A similar process is used to mechanically bond the layers together and aging/prelithiation is used to convert the lithium metal foil layer into a lithium aluminum layer.

In other examples, the anode electrode may include rolled and annealed aluminum foil layers arranged on sides of first and second lithium metal foil layers. The first and second lithium metal foil layers are arranged on opposite sides of an anode current collector (such as a copper foil layer). A similar process is used to mechanically bond the layers together and aging/prelithiation is used to convert the lithium metal foil layers into lithium aluminum layers.

In other examples, the anode electrode may include a rolled and annealed aluminum foil layer and a separator layer arranged on opposite sides of a lithium metal foil layer. A similar process is used to mechanically bond the layers together and aging/prelithiation is used to convert the lithium metal foil layer into a lithium aluminum layer.

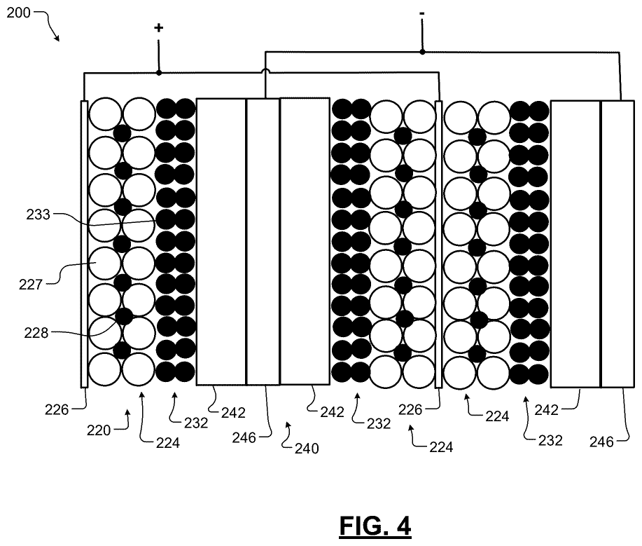

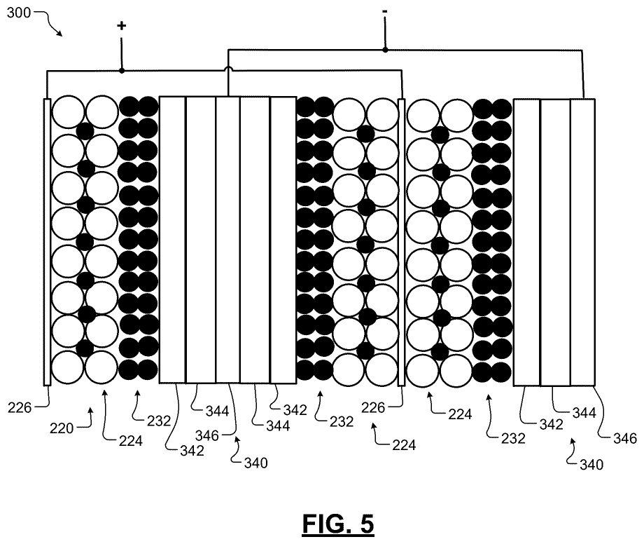

Referring now to FIG. 4, an ASSB cell 200 includes a C cathode electrodes 220, S separators 232, and A anode electrodes 240 where C, S and A are integers greater than zero. The C cathode electrodes 220 include a cathode active material layer 224 and a cathode current collector 226. The cathode active material layer 224 includes cathode active material 227 and a solid electrolyte 228. The S separators 232 include a solid electrolyte 233. The A anode electrodes 240 include an annealed aluminum layer 246 and lithium aluminum (LiAl) layer(s) 242 arranged on one or both sides thereof.

In some examples, loading of the cathode electrodes is in a range from 1 to 10 mAh/cm². In some examples, loading of the cathode electrodes is in a range from 3 to 5 mAh/cm² (e.g., 4 mAh/cm²). In some examples, the separator 232 has a thickness in a range from 5 μm to 150 μm. In some examples, the separator 232 has a thickness in a range from 30 μm to 50 μm (e.g., 40 μm).

In some examples, the annealed aluminum layer acts as an active material and a current collector. In some examples, the thickness of the annealed aluminum layer is in a range from 1 μm to 40 μm. In some examples, the thickness of the annealed aluminum layer is in a range from 5 μm to 15 μm (e.g., 10 μm). In some examples, a grain boundary (GB) distribution (>15°) of the annealed aluminum is in a range from 45% to 80%. In some examples, a grain boundary (GB) distribution) (>15° of the annealed aluminum is in a range from 60% to 70% (e.g., 65%).

In some examples, the pretreated aluminum layer (LiAl Layer) acts as the anode active material and a lithium-ion conductor. In addition to the composition of aluminum, the anode active material further comprises 0.02 to 2.0 mg/cm² (e.g., 1.04 mg/cm²) of lithium. In some examples, the thickness is in a range from 1 μm to 80 μm. In some examples, the thickness is in a range from 30 μm to 50 μm (e.g., 40 μm).

Referring now to FIG. 5, an ASSB cell 300 is similar to the ASSB cell 200 except for the anode electrode. The ASSB cell 300 includes A anode electrodes 340 each including an annealed aluminum layer 342, a lithium aluminum (LiAl) layer 344 arranged on one side of the annealed aluminum layer 342, and an anode current collector 346 (such as a copper foil layer) arranged on one side of the LiAl layer 344. An opposite side of anode current collector 346 can also include the LiAl layer 344 and the annealed aluminum layer 342.

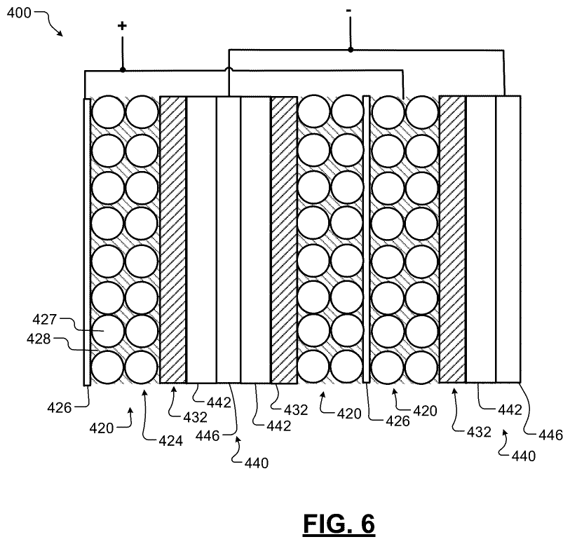

Referring now to FIG. 6, the present disclosure can also be used for other battery cells. A battery cell 400 includes C cathode electrodes 420, S separators 432, and A anode electrodes 440, where A, S and C are integers greater than one. The C cathode electrodes 420 include a cathode active material layer 424 and a cathode current collector 426. The cathode active material layer 424 includes cathode active material 427 and a liquid electrolyte 428. The S separators 432 include a separator layer such as a polymer layer. The A anode electrodes 440 include an annealed aluminum layer 446 and lithium aluminum (LiAl) layer(s) 442 arranged on one or both sides thereof.

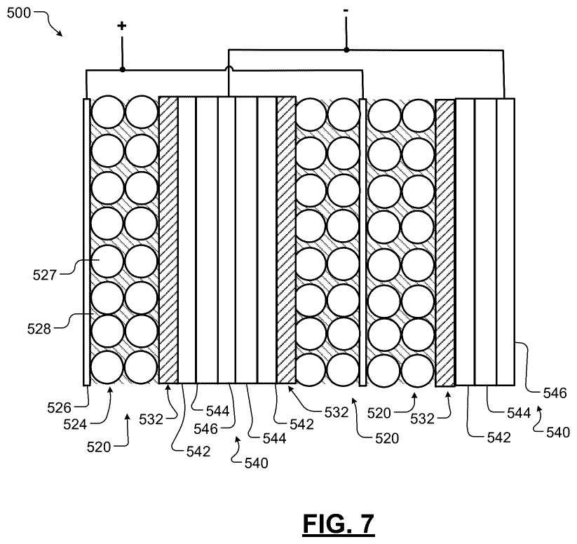

Referring now to FIG. 7, a battery cell 500 includes C cathode electrodes 520, S separators 532, and A anode electrodes 540, where A, S and C are integers greater than one. The C cathode electrodes 520 include a cathode active material layer 524 and a cathode current collector 526. The cathode active material layer 524 includes cathode active material 527 and a liquid electrolyte 528. The S separators 532 include a separator layer (such as a polymer layer). The A anode electrodes 540 include an annealed aluminum layer 542, a lithium aluminum (LiAl) layer 544, and an anode current collector 546 (such as a copper foil layer). As shown above, the opposite side of the anode current collector 546 can optionally include the LiAl layer 544 and the annealed aluminum layer 542.

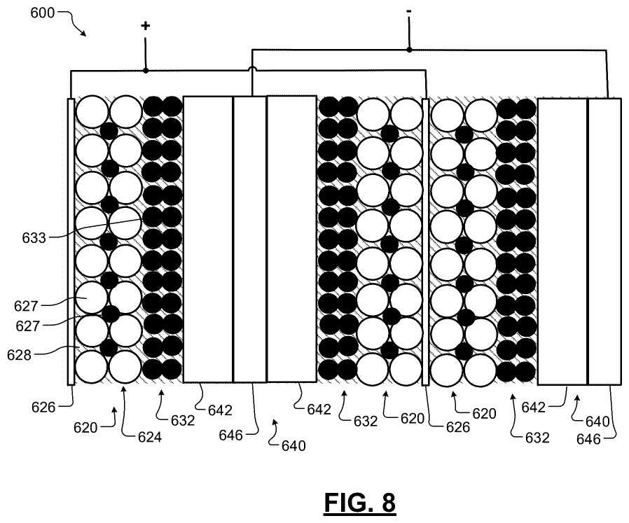

Referring now to FIG. 8, a semi-solid-state battery cell 600 includes C cathode electrodes 620, S separators 632, and A anode electrodes 640, where A, S and C are integers greater than one. The C cathode electrodes 620 include a cathode active material layer 624 and a cathode current collector 626. The cathode active material layer 624 includes cathode active material 627, a solid electrolyte 628, and a liquid electrolyte 629. The S separators 632 include a solid electrolyte 633 and the liquid electrolyte 629. The A anode electrodes 640 include an annealed aluminum layer 646 and a lithium aluminum (LiAl) layer 642 arranged on one or both sides thereof.

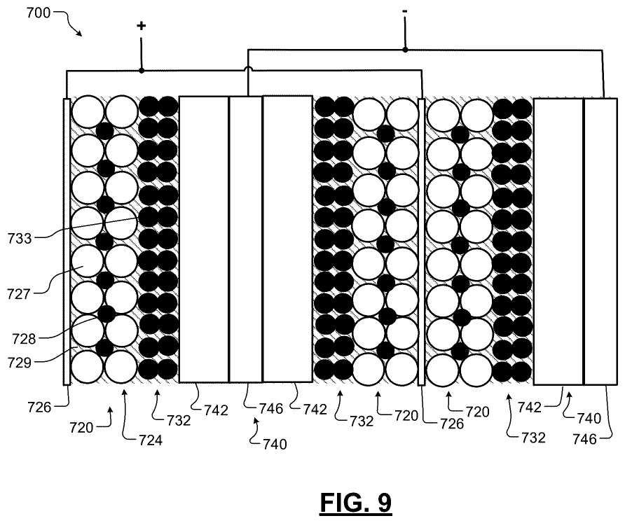

Referring now to FIG. 9, a semi-solid-state battery cell 700 includes C cathode electrodes 720, S separators 732, and A anode electrodes 740, where A, S and C are integers greater than one. The C cathode electrodes 720 include a cathode active material layer 724 and a cathode current collector 726. The cathode active material layer 724 includes cathode active material 727, a solid electrolyte 728, and a liquid electrolyte 729. The S separators 732 include a solid electrolyte 733 and the liquid electrolyte 729. The A anode electrodes 740 include a lithium aluminum (LiAl) layer 742 and an annealed aluminum layer 746 arranged on one or both sides thereof.

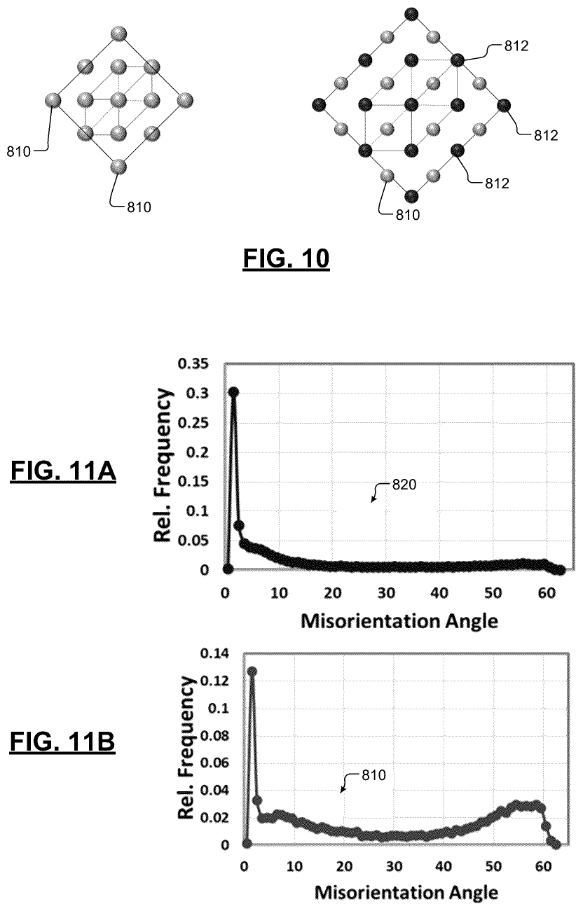

Referring now to FIGS. 10 to 11B, the prelithiation step triggers spontaneous transformation from α phase (Al structure, face-centered cubic (fcc)) to the β phase (LiAl, cubic). The formed LiAl compensates for active lithium loss to enhance the cell cycling (FIG. 10). Aluminum atoms are shown at 810 and lithium atoms are shown at 812. In FIGS. 11A and 11B, aluminum foil is shown before (at 820) and after annealing (at 810). As can be seen, annealing tunes the grain boundary distribution.

Referring now to FIG. 12, grain boundary diffusion is the fastest diffusion path. Phase transition alters the grain boundary (GB) complexion when the Al—Al GBs is changed to LiAl—Al or LiAl—LiAl GBs (with violent GB sliding). Therefore, the GB free volume increases in situ so that the Li diffusion ability along the GBs is enhanced for future Li invasion. For Li atom diffusion in LiAl/Al phase boundaries (PB), the PB interface does not change much because the PB moves vertically and is relatively invariant (keeping a relatively low diffusion ability). GB diffusion is the fastest diffusion path as compared to other paths (phase boundaries, dislocation cores, or lattice). The annealing of Al foil increases the GB distribution, which increases lithium-ion diffusion.

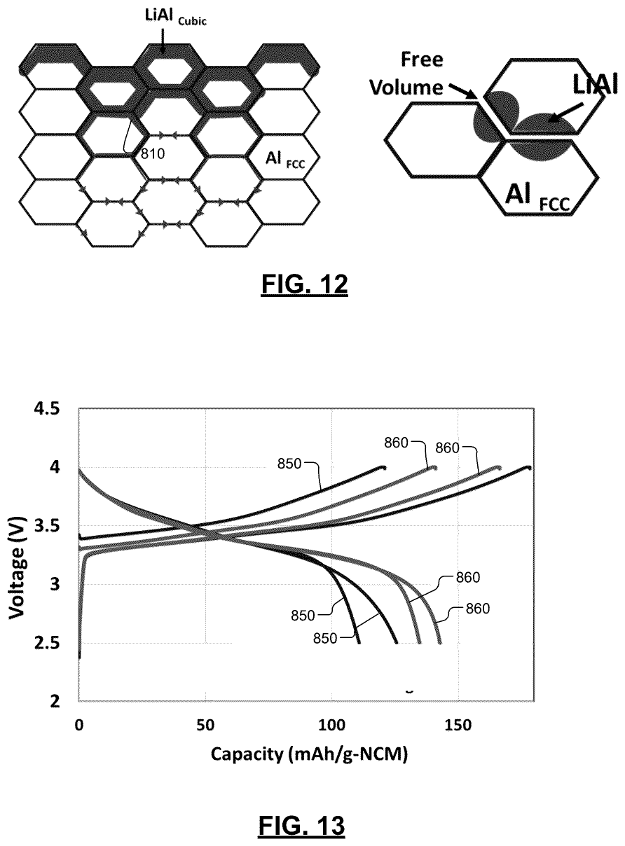

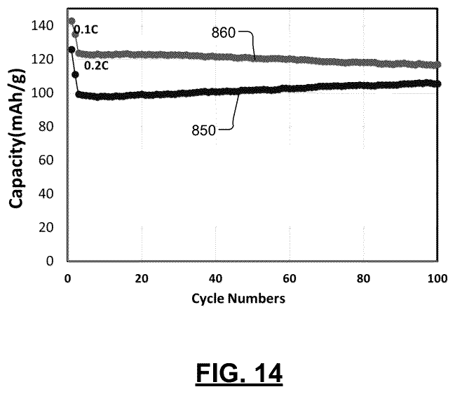

Referring now to FIGS. 13 and 14, electrochemical performance of prelithiated aluminum foil is compared to prelithiated aluminum foil after annealing. In FIG. 13, both battery cells include NCM721 as the cathode active material, sulfide solid electrolyte, and the Al—LiAl anode electrode. Prelithiated aluminum foil is shown at 850 and prelithiated and annealed aluminum foil is shown at 860. An initial charge-discharge (e.g., at 0.1C charge and 25° C.) shows an increase in initial coulombic efficiency from 70% to 86% due to prelithiation after annealing and an increase from 126 mAh/g to 143 mAh/g during 0.1 C discharge. In FIG. 14, performance increased from 99 mAh/g to 124mAh/g during 0.2 C discharge. The prelithiated Al foil after annealing demonstrates enhanced initial Coulombic efficiency and increased capacity delivery due to the boosted Lit diffusion pathways.

In some examples, the cathode active material layer is prepared using a wet-coating process, a dry-film process, a dry-powder coating process, or other suitable manufacturing process. In some examples, the cathode active material layer comprises a cathode material (30 to 98 wt %), an optional solid electrolyte (1 to 50 wt %), and an optional binder (1 to 20 wt %).

In some examples, the cathode active material comprises a layered oxide represented by the formula LiMeO₂, an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, and/or a combination thereof, where Me is a transition metal (e.g., Co, Ni, Mn, Fe, Al, V, or a combination thereof). In some examples, the cathode active material comprises sulfur or Li₂S. In some examples, the cathode active materials identified above are coated with a coating layer (e.g., LiNbO₃ and Li₃PO₄).

In some examples, the binder comprises polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), poly(vinylidene fluoride-co-hexafluoropropylene) (PVDF-HFP), Polyethylene oxide (PEO), Polyacrylonitrile (PAN), Poly(acrylic acid) (PAA), styrene butadiene styrene copolymer (SBS), and so on.

In some examples, the solid electrolyte is selected from a group consisting of sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, and a borate-based solid electrolyte.

Examples of sulfide solid electrolyte include pseudobinary sulfide, pseudoternary sulfide, and pseudoquaternary sulfide. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂Sₛ—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4LiI·0.6Li₄SnS₄ and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of oxide-based solid electrolyte include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃ and Li₁₊ₓ AlₓGe₂₋ₓ(PO₄)₃), and LISICON type (e.g., Li₂₊₂ₓZn₁₋ₓGeO₄).

Examples of metal-doped or aliovalent-substituted oxide solid electrolyte include Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, Al-substituted perovskite, and Li_{1+x+y}AlₓTi₂₋ₓSi_{y}P_{3-y}O₁₂. Examples of nitride-based solid electrolyte include Li₃N, Li₇PN₄, and LiSi₂N₃. Examples of hydride-based solid electrolyte include LiBH₄, LiBH₄—LiX (X=Cl, Br, or I), LiNH₂, Li₂NH, LiBH₄—LiNH₂, and Li₃AlH₆. Examples of halide-based solid electrolyte include LiI, Li₃InCl₆, Li₂CdCl₄, Li₂MgCl₄, Li₂CdI₄, Li₂ZnI₄, and Li₃OcI. Examples of borate-based solid electrolyte include Li₂B₄O₇, and Li₂O—B₂O₃—P₂O₅.

In some examples, the solid electrolyte layer includes a solid electrolyte (in a range from 20 wt % to 100 wt %), an optional conductive filler (in a range from 1 wt % to 30 wt %), and an optional binder (in a range from 0 to 20 wt %).

In some examples, the conductive filler is selected from a group consisting of oxide particles (e.g., SiO₂, Al₂O₃, TiO₂ and ZrO₂), a polymer framework (e.g., polypropylene (PP), polyethylene (PE), a lithium salt (e.g., LiTFSI, Li BF₄), or other suitable conductive filler.

In some examples, the binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS), poly(ethylene oxide) (PEO), polyvinylpyrrolidone (PVP), poly(vinyl alcohol), and poly(acrylic acid) (PAA).

In some examples, the solid electrolyte has a thickness in a range from 5 μm to 200 μm. As can be appreciated, the solid electrolyte in cathode active material layer, the solid electrolyte layer, and the anode layer can be the same or different.

In some examples, the separator layer has a porosity in a range from 5 to 100%. In some examples, the separator layer has a porosity in a range from 85 to 95% (e.g., 90%). In some examples, a liquid electrolyte wets the separator layer.

In some examples, the separator layer includes a polyolefin-based separator (e.g., polyacetylene: polypropylene (PP), polyethylene (PE), dual-layer type: PP-PE, three-layer type: PP-PE-PP). In some examples, the separator layer comprises a cellulose separator, a polyvinylidene fluoride (PVDF) membrane, a porous polyimide membrane, and/or a ceramic-coated separator (such as a SiO₂ coated PE).

In some examples, the separator layer comprises a high-temp-stable separator such as polyimide (PI) nanofiber-based nonwovens, nano-sized Al₂O₃ and poly(lithium 4-styrenesulfonate)-coated polyethylene membrane, SiO₂ coated polyethylene (PE) separator, co-polyimide-coated polyethylene separators, polyetherimides (PEI) (bisphenol-aceton diphthalic anhydride (BPADA) and para-phenylenediamine) separator, expanded polytetrafluoroethylene reinforced polyvinylidenefluoride-hexafluoropropylene separator, sandwich-structured PVdF/PMIA/PVdF nanofibrous separators, and so on.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell, comprising:
C cathode electrodes;
A anode electrodes; and
S separators, where A, C, and S are integers,
wherein each of the A anode electrodes includes:
an annealed aluminum foil layer; and
a lithium aluminum layer arranged on one side of the annealed aluminum foil layer.

2. The battery cell of claim 1, wherein:
the S separators comprise a solid electrolyte,
the C cathode electrodes comprise a cathode active material layer including a cathode active material and a solid electrolyte arranged on one or both sides of a cathode current collector.

3. The battery cell of claim 2, wherein the solid electrolyte is selected from a group consisting of a sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, a borate-based solid electrolyte, and combinations thereof.

4. The battery cell of claim 2, wherein the battery cell comprises an all-solid-state battery cell.

5. The battery cell of claim 1, wherein:
the S separators comprise a solid electrolyte and a liquid electrolyte,
the C cathode electrodes comprise a cathode active material layer including a cathode active material, a solid electrolyte, and a liquid electrolyte, and
the cathode active material layer is arranged on one or both sides of a cathode current collector.

6. The battery cell of claim 5, wherein the solid electrolyte is selected from a group consisting of a sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, a borate-based solid electrolyte, and combinations thereof.

7. The battery cell of claim 1, wherein:
the C cathode electrodes include a cathode active material layer comprising cathode active material and a liquid electrolyte; and
the S separators include a separator layer.

8. The battery cell of claim 7, wherein the separator layer is selected from a group consisting of a polyolefin-based separator, a cellulose separator, a polyvinylidene fluoride (PVDF) membrane, a porous polyimide membrane, and a ceramic-coated separator.

9. The battery cell of claim 7, wherein the separator layer is selected from a group consisting of a polyimide (PI) nanofiber-based nonwoven, a nano-sized Al₂O₃ and poly(lithium 4-styrenesulfonate)-coated polyethylene membrane, a SiO₂ coated polyethylene (PE) separator, a co-polyimide-coated polyethylene separator, a polyetherimide (PEI) separator, an expanded polytetrafluoroethylene reinforced polyvinylidenefluoride-hexafluoropropylene separator, and a sandwich-structured PVdF/PMIA/PVdF nanofibrous separator.

10. The battery cell of claim 1, wherein the C cathode electrodes include a cathode active material selected from a group consisting of a layered oxide, an olivine-type oxide, a monoclinic-type oxide, a spinel-type oxide, a tavorite, sulfur, Li₂S, and combinations thereof.

11. A battery cell, comprising:
C cathode electrodes;
A anode electrodes; and
S separators, where A, C, and S are integers,
wherein each of the A anode electrodes includes:
an annealed aluminum foil layer;
a lithium aluminum layer arranged on one side of the annealed aluminum foil layer; and
a copper current collector arranged on one side of the lithium aluminum layer.

12. The battery cell of claim 11, wherein the C cathode electrodes include a cathode active material layer comprising a cathode active material and a solid electrolyte.

13. The battery cell of claim 12, wherein the solid electrolyte is selected from a group consisting of a sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, a borate-based solid electrolyte, and combinations thereof.

14. The battery cell of claim 11, wherein the S separators comprise a solid electrolyte.

15. The battery cell of claim 14, wherein the solid electrolyte is selected from a group consisting of a sulfide solid electrolyte, an oxide-based solid electrolyte, a metal-doped or aliovalent-substituted oxide solid electrolyte, a nitride-based solid electrolyte, a hydride-based solid electrolyte, a halide-based solid electrolyte, a borate-based solid electrolyte, and combinations thereof.

16. The battery cell of claim 11, wherein:
the C cathode electrodes include a cathode active material layer comprising a cathode active material and a liquid electrolyte, and
the S separators include a separator layer.

17. The battery cell of claim 16, wherein the separator layer is selected from a group consisting of a polyolefin-based separator, a cellulose separator, a polyvinylidene fluoride (PVDF) membrane, a porous polyimide membrane, and a ceramic-coated separator.

18. The battery cell of claim 16, wherein the separator layer is selected from a group consisting of a polyimide (PI) nanofiber-based nonwoven, a nano-sized Al₂O₃ and poly (lithium 4-styrenesulfonate)-coated polyethylene membrane, a SiO₂ coated polyethylene (PE) separator, a co-polyimide-coated polyethylene separator, a polyetherimide (PEI) separator, an expanded polytetrafluoroethylene reinforced polyvinylidenefluoride-hexafluoropropylene separator, and a sandwich-structured PVdF/PMIA/PVdF nanofibrous separator.

19. The battery cell of claim 11, wherein the C cathode electrodes include a cathode active material selected from a group consisting of a layered oxide, an olivine-type oxide, a monoclinic-type oxide, a spinel-type oxide, a tavorite, sulfur, Li₂S, and combinations thereof.
